(19) United States
(12) Patent Application Publication
(10) Pub. No.: US 2007/0197738 A1
(43) Pub. Date: Aug. 23, 2007

(54) Process for making polyesters

(76) Inventors: Deepak Ramaraju, (US); Gomatam Raghavan Ravi, (US); Kyle Patrick Starkey, Woodbury, MN (US); Michael Stephen Donovan, Evansville, IN (US); Parminder Agarwal, Evansville, IN (US)

Correspondence Address: GEAM - O8CV - CPP;IP LEGAL, ONE PLASTICS AVENUE, PITTSFIELD, MA, 01201-3697, US

(21) Appl. No.: 11/336,011

(22) Filed: Jan. 20, 2006

(51) Int. Cl. C08G 63/00; C08F 20/00

(52) U.S. Cl. 525/437; 528/275

(57) ABSTRACT

A process to make a polyester is described wherein said polyester comprises, a) substituted or unsubstituted diacid or diester; b) substituted or unsubstituted diol; wherein said diol comprises at least about 0.5 mole percent of butanediol; and c) 0.01 weight percent to about 15 weight percent based on the total weight of the composition a reactive organic compound wherein said organic compound comprises of at least one functional group.

### BACKGROUND OF THE INVENTION

This invention relates to a process of making a resin composition, more particularly to polyesters.

During the process of manufacture of polyesters such as polybutylene terephthalate (hereinafter also called “PBT”), tetrahydrofuran (hereinafter also called “THF”) is an unwanted side product formed by the cyclization accompanied by dehydration of butanediol monomer (hereinafter also called BDO) or terminal diol groups derived from BDO. This THF formation leads to mismatch of stoichiometry during the polymerization and consequently excess amount of diol is required to balance this mismatch, which results in higher cost of the process. It is a continuing need in industry to reduce the THF formation to make the process economical and obtain a polyester with a minimum amount of such by-products.

Different approaches have been made in order to achieve THF reduction in the manufacture of polyesters. Addition of alkaline salts and reactive additives during polymerization process have been disclosed by U.S. Pat. No. 5,496,887 and J. of App Poly. Sci Vol 45, 371-73 (1992). Japanese patent JP07010981, discloses the use of an alkali metal hydroxide or alkaline earth metal hydroxide for reducing THF formation. Use of allyltriphenyl phosphonium bromide, amides and acid amides like urea during polymerization have been disclosed in US patent—U.S. Pat. No. 5,563,209 and US patent U.S. Pat. No. 4,511,708. Japanese patent JP10324740, describes the use of sodium acetate as an additive during the polymerization process leading to reduced THF formation. Japanese patent JP57085818A discloses the use of alkali metal salts of hypophosphorous acid for reducing THF formation.

Another approach taught by Japanese patent JP2004075756 is addition of additives like epoxies to the polyester during compounding and molding to reduce the amount of residual THF in the polyester. Controlling the stochiometry and reaction conditions have been found to reduce the THF formation in polybutylene naphthalate manufacture in Japanese patent JP04033922A.

In another approach inventors have utilized specific process conditions, which resulted in reduced THF formation, the references for which include Japanese patents JP2002138141A, JP2002363273A, JP2002284868A, JP56024417A, JP52033997A, JP 52017437A and US patent application number 20020128399A1. Yet another approach taught by European patents EP0678552 A1, EP0556050A1, EP0578464A1, EP0683201A1, EP0679672B1 and EP0679672A1, is the addition of aromatic sulfonic acid compound as a co-additive to modify PBT and to reduce THF amount. In another method, use of specific transesterification catalysts and their combination to reduce the formation of THF during polymerization is disclosed in Patent Numbers U.S. Pat. No. 5,900,474A, U.S. Pat. No. 5,237,042A, U.S. Pat. No. 4,780,527A, U.S. Pat. No. 3,936,421A, EP0683201A1, EP0679672A1, EP678552A1 and in J. Poly. Sci Vol 19, 1021 to 1032 (1981).

### BRIEF DESCRIPTION OF THE INVENTION

According to one embodiment of the present invention, a process to make a polyester is described wherein said polyester comprises a) substituted or unsubstituted diacid or diester; b) substituted or unsubstituted diol; wherein said diol comprises at least about 0.5 mole percent of butanediol; and c) 0.01 weight percent to about 15 weight percent based on the total weight of the composition a reactive organic compound wherein said organic compound comprises of at least one functional group; and wherein said process comprises:
heating said diacid, diol and said reactive organic compound at a temperature in the range of between about 125° C. and about 250° C. in presence of an effective amount of catalyst to form a reaction mixture;
removing from said reaction mixture, by-products to form a first mixture;
heating said first mixture at a temperature in the range of between about 180° C. and about 300° C. to form a molten mixture; and
draining said molten mixture to form the polyester.

Various other features, aspects, and advantages of the present invention will become more apparent with reference to the following description, examples, and appended claims.

### DETAILED DESCRIPTION OF THE INVENTION

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

“Combination” as used herein includes mixtures, copolymers, reaction products, blends, composites, and the like.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

As used herein the term “aliphatic radical” refers to a radical having a valence of at least one comprising a linear or branched array of atoms which is not cyclic. The array may include heteroatoms such as nitrogen, sulfur, silicon, selenium and oxygen or may be composed exclusively of carbon and hydrogen. Aliphatic radicals may be “substituted” or “unsubstituted”. A substituted aliphatic radical is defined as an aliphatic radical which comprises at least one substitutent. A substituted aliphatic radical may comprise as many substitutents as there are positions available on the aliphatic radical for substitution. Substituents which may be present on an aliphatic radical include but are not limited to halogen atoms such as fluorine, chlorine, bromine, and iodine. Substituted aliphatic radicals include trifluoromethyl, hexafluoroisopropylidene, chloromethyl; difluorovinylidene; trichloromethyl, bromoethyl, bromotrimethylene (e.g. —CH₂CHBrCH₂—), and the like. For convenience, the term “unsubstituted aliphatic radical” is defined herein to encompass, as part of the “linear or branched array of atoms which is not cyclic” comprising the unsubstituted aliphatic radical, a wide range of functional groups. Examples of unsubstituted aliphatic radicals include allyl, aminocarbonyl (i.e. —CONH₂), carbonyl, dicyanoisopropylidene (i.e.—CH₂C(CN)₂CH₂—), methyl (i.e.—CH₃), methylene (i.e.—CH₂—), ethyl, ethylene, formyl, hexyl, hexamethylene, hydroxymethyl (i.e.—CH₂OH), mercaptomethyl (i.e.—CH₂SH), methylthio (i.e.—SCH₃), methylthiomethyl (i.e.—CH₂SCH₃), methoxy, methoxycarbonyl, nitromethyl (i.e.—CH₂NO₂), thiocarbonyl, trimethylsilyl, t-butyldimethylsilyl, trimethyoxysilypropyl, vinyl, vinylidene, and the like. Aliphatic radicals are defined to comprise at least one carbon atom. A C₁-C₁₀ aliphatic radical includes substituted aliphatic radicals and unsubstituted aliphatic radicals containing at least one but no more than 10 carbon atoms.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n″ is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. Aromatic radicals may be “substituted” or “unsubstituted”. A substituted aromatic radical is defined as an aromatic radical which comprises at least one substitutent. A substituted aromatic radical may comprise as many substitutents as there are positions available on the aromatic radical for substitution. Substituents which may be present on an aromatic radical include, but are not limited to halogen atoms such as fluorine, chlorine, bromine, and iodine. Substituted aromatic radicals include trifluoromethylphenyl, hexafluoroisopropylidenebis(4-phenyloxy) (i.e. —OPhC(CF₃)₂PhO—), chloromethylphenyl; 3-trifluorovinyl-2-thienyl; 3-trichloromethylphenyl (i.e. 3-CCl₃Ph—), bromopropylphenyl (i.e. BrCH₂CH₂CH₂Ph—), and the like. For convenience, the term “unsubstituted aromatic radical” is defined herein to encompass, as part of the “array of atoms having a valence of at least one comprising at least one aromatic group”, a wide range of functional groups. Examples of unsubstituted aromatic radicals include 4-allyloxyphenoxy, aminophenyl (i.e. H₂NPh—), aminocarbonylphenyl (i.e. NH₂COPh—), 4-benzoylphenyl, dicyanoisopropylidenebis(4-phenyloxy) (i.e. —OPhC(CN)₂PhO—), 3-methylphenyl, methylenebis(4-phenyloxy) (i.e.—OPhCH₂PhO—), ethylphenyl, phenylethenyl, 3-formyl-2-thienyl, 2-hexyl-5-furanyl; hexamethylene-1,6-bis(4-phenyloxy) (i.e.—OPh(CH₂)₆PhO—); 4-hydroxymethylphenyl (i.e. 4-HOCH₂Ph—), 4-mercaptomethylphemyl (i.e. 4-HSCH₂Ph—), 4-methylthiophenyl (i.e. 4-CH₃SPh—), methoxyphenyl, methoxycarbonylphenyloxy (e.g. methyl salicyl), nitromethylphenyl (i.e. —PhCH₂NO₂), trimethylsilylphenyl, t-butyldimethylsilylphenyl, vinylphenyl, vinylidenebis(phenyl), and the like. The term “a C₃-C₁₀ aromatic radical” includes substituted aromatic radicals and unsubstituted aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethy group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. Cycloaliphatic radicals may be “substituted” or “unsubstituted”. A substituted cycloaliphatic radical is defined as a cycloaliphatic radical which comprises at least one substitutent. A substituted cycloaliphatic radical may comprise as many substitutents as there are positions available on the cycloaliphatic radical for substitution. Substituents which may be present on a cycloaliphatic radical include but are not limited to halogen atoms such as fluorine, chlorine, bromine, and iodine. Substituted cycloaliphatic radicals include trifluoromethylcyclohexyl, hexafluoroisopropylidenebis(4-cyclohexyloxy) (i.e. —OC₆H₁₁C(CF₃)₂C₆H₁₁O—), chloromethylcyclohexyl; 3-trifluorovinyl-2-cyclopropyl; 3-trichloromethylcyclohexyl (i.e. 3-CCl₃C₆H₁₁—), bromopropylcyclohexyl (i.e. BrCH₂CH₂CH₂C₆H₁₁—), and the like. For convenience, the term “unsubstituted cycloaliphatic radical” is defined herein to encompass a wide range of functional groups. Examples of unsubstituted cycloaliphatic radicals include 4-allyloxycyclohexyl, aminocyclohexyl (i.e. H₂N C₆H₁₁—), aminocarbonylcyclopenyl (i.e. NH₂COC₅H₉—), 4-acetyloxycyclohexyl, dicyanoisopropylidenebis(4-cyclohexyloxy) (i.e. —OC₆H₁₁C(CN)₂C₆H₁₁O—), 3-methylcyclohexyl, methylenebis(4-cyclohexyloxy) (i.e. —OC₆H₁₁CH₂C₆H₁₁O—), ethylcyclobutyl, cyclopropylethenyl, 3-formyl-2-terahydrofuranyl, 2-hexyl-5-tetrahydrofuranyl; hexamethylene-1,6-bis(4-cyclohexyloxy) (i.e. —OC₆H₁₁(CH₂)₆ C₆H₁₁O—); 4-hydroxymethylcyclohexyl (i.e. 4-HOCH₂C₆H₁₁—), 4-mercaptomethylcyclohexyl (i.e. 4-HSCH₂C₆H₁₁—), 4-methylthiocyclohexyl (i.e. 4-CH₃SC₆H₁₁—), 4-methoxycyclohexyl, 2-methoxycarbonylcyclohexyloxy (2-CH₃OCO C₆H, O—), nitromethylcyclohexyl (i.e. NO₂CH₂C₆H₁₀—), trimethylsilylcyclohexyl, t-butyldimethylsilylcyclopentyl, 4-trimethoxysilyethylcyclohexyl (e.g. (CH₃O)₃SiCH₂CH₂C₆H₁₀—), vinylcyclohexenyl, vinylidenebis(cyclohexyl), and the like. The term “a C₃-C₁₀ cycloaliphatic radical” includes substituted cycloaliphatic radicals and unsubstituted cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

According to one embodiment of the present invention, a process to make a polyester is described wherein said polyester comprises a) substituted or unsubstituted diacid or diester; b) substituted or unsubstituted diol; wherein said diol comprises at least about 0.5 mole percent of butanediol; and c) 0.01 weight percent to about 15 weight percent based on the total weight of the composition a reactive organic compound wherein said organic compound comprises of at least one functional group; and wherein said process comprises:
heating said diacid, diol and said reactive organic compound at a temperature in the range of between about 125° C. and about 250° C. in presence of an effective amount of catalyst to form a reaction mixture;
removing from said reaction mixture, by-products to form a first mixture;
heating said first mixture at a temperature in the range of between about 180° C. and about 300° C. to form a molten mixture; and
draining said molten mixture to form the polyester.

Typically such polyester resins include crystalline polyester resins such as polyester resins derived from an aliphatic or cycloaliphatic diol or polyvalent alcohol or mixtures thereof, containing from 2 to about 10 carbon atoms and at least one aromatic dicarboxylic acid. Preferred polyesters are derived from an aliphatic diol and an aromatic dicarboxylic acid and have repeating units according to structural formula (I) 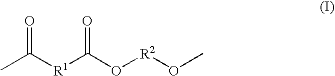
wherein, R¹ and R² are independently at each occurrence a monovalent hydrocarbon group, aliphatic, aromatic and cycloaliphatic radical. In one embodiment R² is an alkyl radical compromising a dehydroxylated residue derived from an aliphatic or cycloaliphatic diol, or mixtures thereof, containing from 2 to about 20 carbon atoms and R¹ is an aromatic radical comprising a decarboxylated residue derived from an aromatic dicarboxylic acid. The polyester is a condensation product where R² is the residue of an aromatic, aliphatic or cycloaliphatic radical containing diol having C₁ to C₃₀ carbon atoms or chemical equivalent thereof, and R¹ is the decarboxylated residue derived from an aromatic, aliphatic or cycloaliphatic radical containing diacid of C₁ to C₃₀ carbon atoms or chemical equivalent thereof. The polyester resins are typically obtained through the condensation or ester interchange polymerization of the diol or diol equivalent component with the diacid or diacid chemical equivalent component.

The diacids meant to include carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, stilbene dicarboxylic acid, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, aliphatic esters, e.g., dialiphatic esters, diaromatic esters, anhydrides, salts, acid chlorides, acid bromides, and the like. Examples of aromatic dicarboxylic acids from which the decarboxylated residue R¹ may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, e.g. 1,4-, 1,5-, or 2,6-naphthalene dicarboxylic acids. Preferred dicarboxylic acids include terephthalic acid, isophthalic acid, stilbene dicarboxylic acids, naphthalene dicarboxylic acids, and the like, and mixtures comprising at least one of the foregoing dicarboxylic acids.

Examples of these polyvalent carboxylic acids include, but are not limited to, an aromatic polyvalent carboxylic acid, an aromatic oxycarboxylic acid, an aliphatic dicarboxylic acid, and an alicyclic dicarboxylic acid, including terephthalic acid, isophthalic acid, ortho-phthalic acid, 1,5-naphthalenedicarboxylic acid, 2,6-naphthalenedicarboxylic acid, diphenic acid, sulfoterephthalic acid, 5-sulfoisophthalic acid, 4-sulfophthalic acid, 4-sulfonaphthalene 2,7-dicarboxylic acid, 5-[4-sulfophenoxy] isophthalic acid, sulfoterephthalic acid, p-oxybenzoic acid, p-(hydroxyethoxy)benzoic acid, succinic acid, adipic acid, azelaic acid, sebacic acid, dodecanedicarboxylic acid, fumaric acid, maleic acid, itaconic acid, hexahydrophthalic acid, tetrahydrophthalic acid, trimellitic acid, trimesic acid, and pyrromellitic acid. These may be used in the form of metal salts and ammonium salts and the like.

Some of the diols useful in the preparation of the polyester resins of the present invention are straight chain, branched, or cycloaliphatic diols and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. In one embodiment the diol include glycols, such as ethylene glycol, propylene glycol, butanediol, hydroquinone, resorcinol, trimethylene glycol, 2-methyl-1,3-propane glycol, 1,4-butanediol, hexamethylene glycol, decamethylene glycol, 1,4-cyclohexane dimethanol, or neopentylene glycol. Chemical equivalents to the diols include esters, such as dialkylesters, diaryl esters, and the like.

Examples of these polyvalent alcohols include, but are not limited to, an aliphatic polyvalent alcohol, an alicyclic polyvalent alcohol, and an aromatic polyvalent alcohol, including ethylene glycol, propylene glycol, 1,3-propanediol, 2,3-butanediol, 1,4-butanediol, 1,5-pentanediol, 1,6-hexanediol, neopentyl glycol, diethylene glycol, dipropylene glycol, 2,2,4-trimethyl-1,3-pentanediol, polyethylene glycol, polypropylene glycol, polytetramethylene glycol, trimethylolethane, trimethylolpropane, glycerin, pentaerythritol, 1,4-cyclohexanediol, 1,4-cyclohexanedimethanol, spiroglycol, tricyclodecanediol, tricyclodecanedimethanol, m-xylene glycol, o-xylene glycol, p-xylene glycol, 1,4-phenylene glycol, bisphenol A, lactone polyester and polyols. Further, with respect to the polyester resin obtained by polymerizing the polybasic carboxylic acids and the polyhydric alcohols either singly or in combination respectively, a resin obtained by capping the polar group in the end of the polymer chain using an ordinary compound capable of capping an end can also be used.

Typically the polyester resin is a poly(butylene dicarboxylate) that may comprise one or more resins selected from linear polyester resins, branched polyester resins and copolymeric polyester resins. Suitable linear polyester resins include, e.g., poly(alkylene phthalate)s such as, e.g., poly(ethylene terephthalate) (“PET”), poly(butylene terephthalate) (“PBT”), poly(propylene terephthalate) (“PPT”), poly(cycloalkylene phthalate)s such as, e.g., poly(cyclohexanedimethanol terephthalate) (“PCT”), poly(alkylene naphthalate)s such as, e.g., poly(butylene-2,6-naphthalate) (“PBN”) and poly(ethylene-2,6-naphthalate) (“PEN”).

Preferred polyesters are obtained by copolymerizing a glycol component and an acid component comprising at least about 0.1 mole %, preferably at least about 95 mole %, of terephthalic acid, or polyester-forming derivatives thereof. The preferred glycol, tetramethylene glycol, component can contain up to about 100 mole %, preferably up to about 0.5 mole % of another glycol, such as ethylene glycol, trimethylene glycol, 2-methyl-1,3-propane glycol, hexamethylene glycol, decamethylene glycol, cyclohexane dimethanol, neopentylene glycol, and the like, and mixtures comprising at least one of the foregoing glycols. The preferred acid component may contain up to about 100 mole %, preferably up to about 50 mole %, of another acid such as isophthalic acid, 2,6-naphthalene dicarboxylic acid, 2,7-naphthalene dicarboxylic acid, 1,5-naphthalene dicarboxylic acid, 4,4′-diphenyl dicarboxylic acid, 4,4′-diphenoxyethanedicarboxylic acid, sebacic acid, adipic acid, and the like, and polyester-forming derivatives thereof, and mixtures comprising at least one of the foregoing acids or acid derivatives.

Block copolyester resin components are also useful, and can be prepared by the transesterification of (a) straight or branched chain poly(alkylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. Especially useful when high melt strength is important are branched high melt viscosity resins, which include a small amount of, e.g., up to 5 mole percent based on the acid units of a branching component containing at least three ester forming groups. The branching component can be one that provides branching in the acid unit portion of the polyester, in the glycol unit portion, or it can be a hybrid branching agent that includes both acid and alcohol functionality. Illustrative of such branching components are tricarboxylic acids, such as trimesic acid, and lower alkyl esters thereof, and the like; tetracarboxylic acids, such as pyromellitic acid, and lower alkyl esters thereof, and the like; or preferably, polyols, and especially preferably, tetrols, such as pentaerythritol; triols, such as trimethylolpropane; dihydroxy carboxylic acids; and hydroxydicarboxylic acids and derivatives, such as dimethyl hydroxyterephthalate, and the like. Branched poly(alkylene terephthalate) resins and their preparation are described, for example, in U.S. Pat. No. 3,953,404 to Borman. In addition to terephthalic acid units, small amounts, e.g., from 0.5 to 15 mole percent of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexylenedimethanol, etc., as well as minor amounts of trifunctional, or higher, branching components, e.g., pentaerythritol, trimethyl trimesate, and the like.

The polyesters in one embodiment of the present invention may be a polyether ester block copolymer consisting of a thermoplastic polyester as the hard segment and a polyalkylene glycol as the soft segment. It may also be a three-component copolymer obtained from at least one dicarboxylic acid selected from: aromatic dicarboxylic acids such as terephthalic acid, isophthalic acid, phthalic acid, naphthalene-2,6-dicarboxylic acid, naphthalene-2,7-dicarboxylic acid, diphenyl-4,4-dicarboxylic acid, diphenoxyethanedicarboxylic acid or 3-sulfoisophthalic acid, alicyclic dicarboxylic acids such as 1,4-cyclohexanedicarboxylic acid, aliphatic dicarboxylic acids such as succinic acid, oxalic acid, adipic acid, sebacic acid, dodecanedicarboxylic acid or dimeric acid, and ester-forming derivatives thereof; at least one diol selected from: aliphatic diols such as 1,4-butanediol, ethylene glycol, trimethylene glycol, tetramethylene glycol, pentamethylene glycol, hexamethylene glycol, neopentyl glycol or decamethylene glycol, alicyclic diols such as 1,1-cyclohexanedimethanol, 1,4-cyclohexanedimethanol or tricyclodecanedimethanol, and ester-forming derivatives thereof; and at least one poly(alkylene oxide) glycol selected from: polyethylene glycol or poly(1,2-and 1,3-propylene oxide) glycol with an average molecular weight of about 400-5000, ethylene oxide-propylene oxide copolymer, and ethylene oxide-tetrahydrofuran copolymer.

The polyester can be present in the composition at about 1 to about 99 weight percent, based on the total weight of the composition. Within this range, it is preferred to use at least about 25 weight percent, even more preferably at least about 30 weight percent of the polyester such as poly(butylene terephthalate). The preferred polyesters preferably have an intrinsic viscosity (as measured in 60:40 solvent mixture of phenol/tetrachloroethane at 25° C.) ranging from about 0.1 to about 1.5 deciliters per gram. Polyesters branched or unbranched generally will have a weight average molecular weight of from about 5,000 to about 150,000, preferably from about 8,000 to about 95,000 as measured by gel permeation chromatography using 95:5 weight percent of chloroform to hexafluoroisopropanol mixture.

In one embodiment the polyester comprises at least about 0.5 mole percent of butanediol. In another embodiment the polyester comprises butanediol in a range from about 1 to 100 mole percent of butanediol.

In one embodiment the polyester comprises a reactive organic compound wherein the reactive organic compound comprises at least one functional group. The reactive organic compound comprising at least one functional group is at least one selected from the group consisting of aliphatic or aromatic compounds. The functional group is at least one selected from the group consisting of epoxy, carbodiimide, orthoester, anhydride, oxazoline, imidazoline, isocyanate. In an embodiment the functional group is selected from the group consisting of epoxy, imidazoline, oxazoline.

According to an embodiment, the reactive organic compound comprising at least one functional group may include multifunctional epoxies. In one embodiment the stabilized composition of the present invention may optionally comprise at least one epoxy-functional polymer. One epoxy polymer is an epoxy functional (alkyl)acrylic monomer and at least one non-functional styrenic and/or (alkyl)acrylic monomer. In one embodiment, the epoxy polymer has at least one epoxy-functional (meth)acrylic monomer and at least one non-functional styrenic and/or (meth)acrylic monomer which are characterized by relatively low molecular weights. In another embodiment the epoxy functional polymer may be epoxy-functional styrene (meth)acrylic copolymers produced from monomers of at least one epoxy functional (meth)acrylic monomer and at least one non-functional styrenic and/or (meth)acrylic monomer. As used herein, the term (meth) acrylic includes both acrylic and methacrylic monomers. Non-limiting examples of epoxy-functional (meth)acrylic monomers include both acrylates and methacrylates. Examples of these monomers include, but are not limited to, those containing 1,2-epoxy groups such as glycidyl acrylate and glycidyl methacrylate. Other suitable epoxy-functional monomers include allyl glycidyl ether, glycidyl ethacrylate, and glycidyl itaconate.

Epoxy functional materials suitable for use as the carboxyl reactive group contain aliphatic or cycloaliphatic epoxy or polyepoxy functionalization. Generally, epoxy functional materials suitable for use herein are derived by the reaction of an epoxidizing agent, such as peracetic acid, and an aliphatic or cycloaliphatic point of unsaturation in a molecule. Other functionalities which will not interfere with an epoxidizing action of the epoxidizing agent may also be present in the molecule, for example, esters, ethers, hydroxy, ketones, halogens, aromatic rings, etc. A well known class of epoxy functionalized materials are glycidyl ethers of aliphatic or cycloaliphatic alcohols or aromatic phenols. The alcohols or phenols may have more than one hydroxyl group. Suitable glycidyl ethers may be produced by the reaction of, for example, monophenols or diphenols described in Formula I such as bisphenol-A with epichlorohydrin. Polymeric aliphatic epoxides might include, for example, copolymers of glycidyl methacrylate or allyl glycidyl ether with methyl methacrylate, styrene, acrylic esters or acrylonitrile.

Specifically, the epoxies that can be employed herein include glycidol, bisphenol-A diglycidyl ether, tetrabromobisphenol-A diglycidyl ether, diglycidyl ester of phthalic acid, diglycidyl ester of hexahydrophthalic acid, epoxidized soybean oil, butadiene diepoxide, tetraphenylethylene epoxide, dicyclopentadiene dioxide, vinylcyclohexene dioxide, bis(3,4-epoxy-6-methylcyclohexylmethyl)adipate, and 3,4-epoxycyclohexylmethyl-3,4-epoxycyclohexane carboxylate (ERL).

According to an embodiment, such additional carboxyl reactive groups may include reactive oxazoline compounds, which are also known as cyclic imino ether compounds. Such compounds are described in Van Benthem, Rudolfus A. T. et al., U.S. Pat. No. 6,660,869 or in Nakata, Yoshitomo et al., U.S. Pat. No. 6,100,366. Examples of such compounds are phenylene bisoxazolines (hereinafter also called “PBO”), 1,3-PBO, 1,4-PBO, 1,2-naphthalene bisoxazoline, 1,8-naphthalene bisoxazoline, 1,11-dimethyl-1,3-PBO and 1,11-dimethyl-1,4-PBO.

In another embodiment, the carboxyl reactive group can be oligomeric copolymer of vinyl oxazoline and acrylic monomers. Specific examples of preferable oxazoline monomers include 2-vinyl-2-oxazoline, 5-methyl-2-vinyl-2-oxazoline, 4,4-dimethyl-2-vinyl-2-oxazoline, 4,4-dimethyl-2-vinyl-5,5-dihydro-4H-1,3-oxazoline, 2-isopropenyl-2-oxazoline, and 4,4-dimethyl-2-isopropenyl-2-oxazoline. Particularly, 2-isopropenyl-2-oxazoline and 4,4-dimethyl-2-isopropenyl-2-oxazoline are preferable, because they show good copolymerizability. The monomer component may further include other monomers copolymerizable with the cyclic imino ether group containing monomer. Examples of such other monomers include unsaturated alkyl carboxylate monomers, aromatic vinyl monomers, and vinyl cyanide monomers. These other monomers may be used either alone respectively or in combinations with each other. Examples of the unsaturated alkyl carboxylate monomer include methyl (meth)acrylate, ethyl (meth)acrylate, propyl (meth)acrylate, n-butyl (meth)acrylate, iso-butyl (meth)acrylate, t-butyl (meth)acrylate, 2-ethylhexyl (meth)acrylate, n-octyl (meth)acrylate, iso-nonyl (meth)acrylate, dodecyl (meth)acrylate, and stearyl (meth)acrylate, styrene and α-methyl styrene.

In one embodiment the reactive organic compound comprises bisoxazolines for the formula (II) 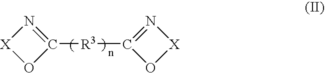
wherein X is a bivalent group, and wherein X gives a 5-membered ring or 6-membered ring and R³ is at least one bivalent group selected from aliphatic, aromatic or cycloaliphatic groups, and n is an integer from 0 to 5. In one embodiment X is at least one selected from the group consisting of a substituted or unsubstituted ethylene group, or substituted or unsubstituted trimethylene group. The substitution on the ethylene or trimethylene group is selected from the group consisting of methyl, ethyl, hexyl, alkylhexyl, nonyl, phenyl, naphthyl, diphenyl, or cyclohexyl groups. In one embodiment, the bisoxazolines is at least one selected from the group consisting of 2,2′-bis(2-oxazoline), 2,2′-bis(4-methyl-2-oxazoline), 2,2′-bis(4-phenyl-2-oxazoline), 2,2′-bis(4-hexyloxazoline), 2,2′-p-phenylenebis(2-oxazoline), 2,2′-m-phenylenebis(2-oxazoline), 2,2′-tetramethylenebis(4,4′-dimethyl-2-oxazoline).

In one embodiment, the reactive organic compound comprising at least one functional group is selected from the group consisting of epoxy and orthoester. In one embodiment the reactive organic compound comprising at least one functional group is of the formula (III) 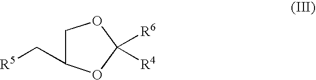
wherein R⁴, R⁵, R⁶ are independently at any occurrence an alkyl, alkoxy, aromatic, aryloxy, hydroxy, or hydrogen, alkoxy or aryloxy or hydroxy. In yet another embodiment the reactive organic compound comprising at least one functional group is of the formula (IV) 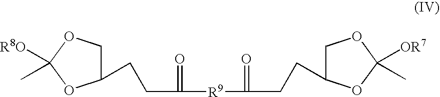
wherein R⁷, R⁸ are independently at each occurrence selected from the group consisting of alkyl, aromatic, hydrogen and R⁹ is an aromatic radical.

According to an embodiment, such additional carboxyl reactive groups may include reactive imidazoline compounds. These imidazoline compounds are preferably 2-imidazolines as described in the references, Synthesis, Vol 12, Page 963 to 965, 1981 and Chemical Review, 54, 593-613 (1954). Typically, the imidazoline compound comprises at least one imidazoline group and not restricted 1,3-phenylene-bisimidazoline, or 1,4-phenylene-bisimidazoline. A typical process to prepare 1,4-phenylene-bisimidazoline includes the condensation of p-benzodinitrile with ethylene diamine.

Typically, the reactive organic compound comprising at least one functional group is present in a range of between about 0.01 weight percent and about 15 weight percent based on the total weight of the composition. In another embodiment the reactive organic compound comprising at least one functional group is present in a range of between about 0.01 weight percent and about 2 weight percent based on the total weight of the composition. In yet another embodiment the reactive organic compound comprising at least one functional group is present in a range of between about 0.1 weight percent and about 0.5 weight percent based on the total weight of the composition.

In one embodiment the reactive organic compound may be added in total to the reaction mixture. In another embodiment the reactive organic compound may be added to the first mixture. In another embodiment the reactive organic compound is added in two split additions, i.e. to the reaction mixture and the first mixture. In another embodiment the reactive organic compound may be added in three split additions, i.e., to the reaction mixture, the first mixture and the final melt mixture. In another embodiment the reactive organic compound is added to the melt mixture. In yet another embodiment the reactive organic compound may be added stepwise during the entire course of the process.

In one embodiment of the present invention a catalyst may be employed. The catalyst can be any of the catalysts commonly used in the prior art such as alkaline earth metal oxides such as magnesium oxides, calcium oxide, barium oxide and zinc oxide; alkali and alkaline earth metal salts; a Lewis catalyst such as tin or titananium compounds; a nitrogen-containing compound such as tetra-alkyl ammonium hydroxides used like the phosphonium analogues, e.g., tetra-alkyl phosphonium hydroxides or acetates. The Lewis acid catalysts and the aforementioned metal oxide or salts can be used simultaneously.

Inorganic catalysts include compounds such as the hydroxides, hydrides, amides, carbonates, phosphates, borates, carboxylates etc., of alkali metals such as sodium, potassium, lithium, cesium, etc., and of alkali earth metals such as calcium, magnesium, barium, etc., can be cited such as examples of alkali or alkaline earth metal compounds. Typical examples include sodium stearate, sodium carbonate, sodium acetate, sodium bicarbonate, sodium benzoate, sodium caproate, or potassium oleate.

In one embodiment of the invention, the catalyst is selected from one of phosphonium salts or ammonium salts (not being based on any metal ion) for improved hydrolytic stability properties. In another embodiment of the invention, the catalyst is selected from one of: a sodium stearate, a sodium benzoate, a sodium acetate, and a tetrabutyl phosphonium acetate. In yet another embodiment of the present invention the catalysts is selected independently from a group of sodium stearate, zinc stearate, calcium stearate, magnesium stearate, sodium acetate, calcium acetate, zinc acetate, magnesium acetate, manganese acetate, lanthanum acetate, lanthanum acetylacetonate, sodium benzoate, sodium tetraphenyl borate, dibutyl tin oxide, antimony trioxide, sodium polystyrenesulfonate, titanium isoproxide and tetraammoniumhydrogensulfate and mixtures thereof. In an alternative embodiment the here said catalyst may be a compound of the form M(OR¹⁰)_{q} where M is an alkaline earth or alkali metal, such as sodium, potassium, lithium, cesium, etc., and of alkali earth metals such as calcium, magnesium, barium, etc. metals and transitional metals like aluminium, magnesium, manganese, zinc, titanium, nickel and R¹⁰ can be an aliphatic or aromatic organic compound such as methyl, ethyl, propyl, phenyl etc and q is the valence of the metal corresponding to the compound.

In one embodiment the catalysts include, but are not limited to metal salts and chelates of Ti, Zn, Ge, Ga, Sn, Ca, Li and Sb. Other known catalysts may also be used for this step-growth polymerization. The choice of catalyst being determined by the nature of the reactants. In one embodiment of the present invention the reaction mixture comprises at least two catalysts. The various catalysts for use herein are very well known in the art and are too numerous to mention individually herein. A few examples of the catalysts which may be employed in the above process include but are not limited to titanium alkoxides. such as tetramethyl, tetraethyl, tetra(n-propyl), tetraisopropyl and tetrabutyl titanates; dialkyl tin compounds, such as di-(n-butyl) tin dilaurate. di-(n-butyl) tin oxide and di-(n-butyl) tin diacetate; acetate salts and sulfate salts of metals, such as magnesium, calcium, germanium, zinc, antimony, etc. In one embodiment the catalyst is titanium alkoxides. The catalyst level is employed in an effective amount to enable the copolymer formation and is not critical and is dependent on the catalyst that is used. Generally the catalyst is used in concentration ranges of about 5 to about 2000 ppm, preferably about is less than about 1000 ppm and most preferably about 20 to about 1000 ppm.

In another embodiment a catalyst quencher may optionally be added to the reaction mixture. The choice of the quencher is essential to avoid color formation and loss of clarity of the thermoplastic composition. In one embodiment of the invention, the catalyst quenchers are phosphorus containing derivatives, examples include but are not limited to diphosphites, phosphonates, metaphosphoric acid; arylphosphinic and arylphosphonic acids; polyols; carboxylic acid derivatives and combinations thereof. The amount of the quencher added to the thermoplastic composition is an amount that is effective to stabilize the thermoplastic composition. In one embodiment the amount is at least about 0.001 weight percent, preferably at least about 0.01 weight percent based on the total amounts of said thermoplastic resin compositions. The amount of quencher used is not more than the amount effective to stabilize the composition in order not to deleteriously affect the advantageous properties of said composition.

The process of the present invention may further include additives which do not interfere with the previously mentioned desirable properties but enhance other favorable properties such as anti-oxidants, flame retardants, reinforcing materials, colorants, mold release agents, fillers, nucleating agents, UV light and heat stabilizers, lubricants, and the like. Additionally, additives such as antioxidants, minerals such as talc, clay, mica, and other stabilizers including but not limited to UV stabilizers, such as benzotriazole, supplemental reinforcing fillers such as flaked or milled glass, and the like, flame retardants, pigments or combinations thereof may be added to the compositions of the present invention.

The compositions may, optionally, further comprise a reinforcing filler. The fillers may be of natural or synthetic, mineral or non-mineral origin, provided that the fillers have sufficient thermal resistance to maintain their solid physical structure at least at the processing temperature of the composition with which it is combined. Suitable fillers include clays, nanoclays, carbon black, wood flour either with or without oil, various forms of silica (precipitated or hydrated, fumed or pyrogenic, vitreous, fused or colloidal, including common sand), glass, metals, inorganic oxides (such as oxides of the metals in Periods 2, 3, 4, 5 and 6 of Groups Ib, IIb, IIIa, IIIb, IVa, IVb (except carbon), Va, VIIa, VIIa and VIII of the Periodic Table), oxides of metals (such as aluminum oxide, titanium oxide, zirconium oxide, titanium dioxide, nanoscale titanium oxide, aluminum trihydrate, vanadium oxide, and magnesium oxide), hydroxides of aluminum or ammonium or magnesium, carbonates of alkali and alkaline earth metals (such as calcium carbonate, barium carbonate, and magnesium carbonate), antimony trioxide, calcium silicate, diatomaceous earth, fuller earth, kieselguhr, mica, talc, slate flour, volcanic ash, cotton flock, asbestos, kaolin, alkali and alkaline earth metal sulfates (such as sulfates of barium and calcium sulfate), titanium, zeolites, wollastonite, titanium boride, zinc borate, tungsten carbide, ferrites, molybdenum disulfide, asbestos, cristobalite, aluminosilicates including Vermiculite, Bentonite, montmorillonite, Na-montmorillonite, Ca-montmorillonite, hydrated sodium calcium aluminum magnesium silicate hydroxide, pyrophyllite, magnesium aluminum silicates, lithium aluminum silicates, zirconium silicates, and combinations comprising at least one of the foregoing fillers. Suitable fibrous fillers include glass fibers, basalt fibers, aramid fibers, carbon fibers, carbon nanofibers, carbon nanotubes, carbon buckyballs, ultra high molecular weight polyethylene fibers, melamine fibers, polyamide fibers, cellulose fiber, metal fibers, potassium titanate whiskers, and aluminum borate whiskers.

Alternatively, or in addition to a particulate filler, the filler may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

Optionally, the fillers may be surface modified, for example treated so as to improve the compatibility of the filler and the polymeric portions of the compositions, which facilitates deagglomeration and the uniform distribution of fillers into the polymers. One suitable surface modification is the durable attachment of a coupling agent that subsequently bonds to the polymers. Use of suitable coupling agents may also improve impact, tensile, flexural, and/or dielectric properties in plastics and elastomers; film integrity, substrate adhesion, weathering and service life in coatings; and application and tooling properties, substrate adhesion, cohesive strength, and service life in adhesives and sealants. Suitable coupling agents include silanes, titanates, zirconates, zircoaluminates, carboxylated polyolefins, chromates, chlorinated paraffins, organosilicon compounds, and reactive cellulosics. The fillers may also be partially or entirely coated with a layer of metallic material to facilitate conductivity, e.g., gold, copper, silver, and the like.

In a preferred embodiment, the reinforcing filler comprises glass fibers. For compositions ultimately employed for electrical uses, it is preferred to use fibrous glass fibers comprising lime-aluminum borosilicate glass that is relatively soda free, commonly known as “E” glass. However, other glasses are useful where electrical properties are not so important, e.g., the low soda glass commonly known as “C” glass. The glass fibers may be made by standard processes, such as by steam or air blowing, flame blowing and mechanical pulling. Preferred glass fibers for plastic reinforcement may be made by mechanical pulling. The diameter of the glass fibers is generally about 1 to about 50 micrometers, preferably about 1 to about 20 micrometers. Smaller diameter fibers are generally more expensive, and glass fibers having diameters of about 10 to about 20 micrometers presently offer a desirable balance of cost and performance. The glass fibers may be bundled into fibers and the fibers bundled in turn to yarns, ropes or rovings, or woven into mats, and the like, as is required by the particular end use of the composition. In preparing the molding compositions, it is convenient to use the filamentous glass in the form of chopped strands of about one-eighth to about 2 inches long, which usually results in filament lengths between about 0.0005 to about 0.25 inch in the molded compounds. Such glass fibers are normally supplied by the manufacturers with a surface treatment compatible with the polymer component of the composition, such as a siloxane, titanate, or polyurethane sizing, or the like.

When present in the composition, the filler may be used at about 0 to about 60 weight percent, based on the total weight of the composition. Within this range, it is preferred to use at least about 20 weight percent of the reinforcing filler. Also within this range, it is preferred to use up to about 50 weight percent, more preferably up to about 40 weight percent, of the reinforcing filler.

Flame-retardant additives are desirably present in an amount at least sufficient to reduce the flammability of the polyester resin, preferably to a UL94 V-0 rating. The amount will vary with the nature of the resin and with the efficiency of the additive. In general, however, the amount of additive will be from 1 to 30 percent by weight based on the weight of resin. A preferred range will be from about 5 to 20 percent.

Typically halogenated aromatic flame-retardants include tetrabromobisphenol A polycarbonate oligomer, polybromophenyl ether, brominated polystyrene, brominated BPA polyepoxide, brominated imides, brominated polycarbonate, poly (haloaryl acrylate), poly (haloaryl methacrylate), or mixtures thereof. Examples of other suitable flame retardants are brominated polystyrenes such as polydibromostyrene and polytribromostyrene, decabromobiphenyl ethane, tetrabromobiphenyl, brominated alpha, omega-alkylene-bis-phthalimides, e.g. N,N′-ethylene-bis-tetrabromophthalimide, oligomeric brominated carbonates, especially carbonates derived from tetrabromobisphenol A, which, if desired, are end-capped with phenoxy radicals, or with brominated phenoxy radicals, or brominated epoxy resins.

The flame retardants are typically used with a synergist, particularly inorganic antimony compounds. Such compounds are widely available or can be made in known ways. Typical, inorganic synergist compounds include Sb₂O₅, SbS₃, sodium antimonate and the like. Especially preferred is antimony trioxide (Sb₂O₃). Synergists such as antimony oxides, are typically used at about 0.1 to 10 by weight based on the weight percent of resin in the final composition. Also, the final composition may contain polytetrafluoroethylene (PTFE) type resins or copolymers used to reduce dripping in flame retardant thermoplastics. Also other halogen-free flame retardants than the mentioned P or N containing compounds can be used, non limiting examples being compounds as Zn-borates, hydroxides or carbonates as Mg- and/or Al-hydroxides or carbonates, Si-based compounds like silanes or siloxanes, Sulfur based compounds as aryl sulphonates (including salts of it) or sulphoxides, Sn-compounds as stannates can be used as well often in combination with one or more of the other possible flame retardants.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl) propionic acid with mono-or polyhydric alcohols, e.g., with methanol, diethylene glycol, octadecanol, triethylene glycol, 1,6-hexanediol, pentaerythritol, neopentyl glycol, tris(hydroxyethyl) isocyanurate, thiodiethylene glycol, N,N-bis(hydroxyethyl) oxalic acid diamide. Typical, UV absorbers and light stabilizers include i) 2-(2′-hydroxyphenyl)-benzotriazoles, for example, the 5′methyl-,3′5′-di-tert-butyl-,5′-tert-butyl-,5′(1,1,3,3-tetramethylbutyl)-,5-chloro-3′,5′-di-tert-butyl-,5-chloro-3′tert-butyl-5′methyl-,3 ′sec-butyl-5′tert-butyl-,4′-octoxy,3′,5′-ditert-amyl-3′,5′-bis-(alpha, alpha-dimethylbenzyl)-derivatives; ii) 2.2 2-Hydroxy-benzophenones, for example, the 4-hydroxy-4-methoxy-,4-octoxy,4-decloxy-,4-dodecyloxy-,4-benzyloxy,4,2′,4′-trihydroxy-and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4-tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate.

The composition can further comprise one or more anti-dripping agents, which prevent or retard the resin from dripping while the resin is subjected to burning conditions. Specific examples of such agents include silicone oils, silica (which also serves as a reinforcing filler), asbestos, and fibrillating-type fluorine-containing polymers. Examples of fluorine-containing polymers include fluorinated polyolefins such as, for example, poly(tetrafluoroethylene), tetrafluoroethylene/hexafluoropropylene copolymers, tetrafluoroethylene/ethylene copolymers, polyvinylidene fluoride, poly(chlorotrifluoroethylene), and the like, and mixtures comprising at least one of the foregoing anti-dripping agents. A preferred anti-dripping agent is poly(tetrafluoroethylene). When used, an anti-dripping agent is present in an amount of about 0.02 to about 2 weight percent, and more preferably from about 0.05 to about 1 weight percent, based on the total weight of the composition.

Dyes or pigments may be used to give a background coloration. Dyes are typically organic materials that are soluble in the resin matrix while pigments may be organic complexes or even inorganic compounds or complexes, which are typically insoluble in the resin matrix. These organic dyes and pigments include the following classes and examples: furnace carbon black, titanium oxide, zinc sulfide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

Typically the additive is generally present in amount corresponding to about 0 to about 1.5 weight percent based on the amount of resin. In another embodiment the additive is generally present in amount corresponding to about 0.01 to about 0.5 weight percent based on the amount of resin.

The polyesters in one embodiment have an intrinsic viscosity (as measured in 60:40 solvent mixture of phenol/tetrachloroethane at 25° C.) ranging from about 0.3 to about 1.5 deciliters per gram. In one embodiment of the present invention the polyesters may be branched or unbranched and having a weight average molecular weight of at least greater than 15000, preferably from about 25000 to about 150000 as measured by gel permeation chromatography using 95:5 weight percent of chloroform and hexafluoroisopropanol mixture

In one embodiment of the present invention the polyesters are prepared by melt process. The process may be a continuous polymerization process wherein the said reaction is conducted in a continuous mode in a train of reactors of atleast two in series or parallel. The reactants and additives inclusive of catalysts and co-catalysts are all added as a mixture with any of the monomers or continuously added as separate additions in the first reactor or in any of the reactors in the train. In an alternate embodiment the process may be a batch polymerization process wherein the reaction is conducted in a batch mode in a single vessel or in multiple vessels and the reaction can be conducted in two or more stages depending on the number of reactors and the process conditions. In an alternate embodiment, the process can be carried out in a semi-continuous polymerization process where the reaction is carried out in a batch mode and the additives are added continuously. Alternatively, the reaction is conducted in a continuous mode where the polymer formed is removed continuously and the reactants or additives are added in a batch process. In an alternate embodiment the product from atleast one of the reactors can be recycled back into the same reactor intermittently by “pump around” to improve the mass transfer and kinetics of reaction. Alternatively the reactants and the additives are stirred in the reactors with a speed of about 25 revolutions per minute (here in after “rpm”) to about 2500 rpm.

In another embodiment, the additives and the reactants can be added together or individually. The method of addition can be dosing of the material or the drop and weight feeding in case of solids into the reactor vessel or spraying of liquids into the reactor. In yet another embodiment some of the unreacted reactants or additives may be recycled back after recovery or after distillation or by a similar process well known to a person skilled in the state of art. In one embodiment of the present invention the process may be carried out in an inert atmosphere. The inert atmosphere may be either nitrogen or argon or carbon dioxide. The heating of the various ingredients may be carried out in a temperature between about 90° C. and about 230° C. and at a pressure of about 300 kPa to about 80 kPa.

In one embodiment the by-products such as THF are removed from the reaction mixture by methods well known to those skilled in the art. In one embodiment the by-products are removed by distillation. The distillation may be carried out under vacuum or under a pressure of about 300 kPa. In another embodiment distillation may be carried under a pressure between about 0.01 kPa and about 90 kPa. In an alternate embodiment one of the distillation products may be recycled back into the reaction.

In one embodiment the byproduct comprises of methanol, water and THFand some excess butanediol. In one embodiment the amount of butanediol employed for the process is reduced by at least about 10 mole % of monomer charged. In another embodiment the by-product consists essentially of THF. The THF that is removed from the reaction mixture by distillation and collected after condensation is known as the overhead THF, while there may still be some amount of THF present in the final polyester which is referred to as the residual THF. In one embodiment the amount of overhead THF is at least about 0.0001 weight percent based on the polyester. In another embodiment the amount of overhead THF is in the range of between about 0.1 weight percent and about 75 weight percent based on polyester.

In one embodiment the ingredients are heated to a temperature between 125° C. and about 250° C. and at a pressure of about 300 kPa to 30 kPa to form the first mixture. The first mixture is heated to a temperature between about 175° C. and about 300° C. to form a molten mixture. In one embodiment the process is carried out at a pressure of about 0.01 kPa to atmospheric pressure. In yet another embodiment the vacuum is between 0.01 kPa to 80 kPa.

In one embodiment the reaction is then carried out under vacuum of about 0.01 kPa while the reaction occurs and polyester of desired molecular weight is built. In one embodiment the polyester is recovered by isolating the polymer followed by grinding or by extruding the hot polymer melt, cooling and pelletizing.

The reaction may be conducted optionally in presence of a solvent or in neat conditions without the solvent. The organic solvent used in the above process according to the invention should be capable of dissolving the polyester to an extent of at least 0.01 g/per ml at 25° C. and should have a boiling point in the range of 140-290° C. at atmospheric pressure. Preferred examples of the solvent include but are not limited to amide solvents, in particular, N-methyl-2-pyrrolidone; N-acetyl-2-pyrrolidone; N,N′-dimethyl formamide; N,N′-dimethyl acetamide; N,N′-diethyl acetamide; N,N′-dimethyl propionic acid amide; N,N′-diethyl propionic acid amide; tetramethyl urea; tetraethyl urea; hexamethylphosphor triamide; N-methyl caprolactam and the like. Other solvents may also be employed, for example, methylene chloride, chloroform, 1,2-dichloroethane, tetrahydrofuran, diethyl ether, dioxane, benzene, toluene, chlorobenzene, o-dichlorobenzene and the like.

In one embodiment the reactive organic compound is added along with the diol and diacid to form the reaction mixture. In another embodiment the reactive organic compound is added at various stages in the process. In yet another embodiment a part of the reactive organic compound is added to the reaction mixture and a part is added to the first mixture. In an alternate embodiment a part of the reactive organic compound is added to the reaction mixture and a part is added to the molten mixture.

In one embodiment the polyester composition may be made by conventional blending techniques. The production of the compositions may utilize any of the blending operations known for the blending of thermoplastics, for example blending in a kneading machine such as a Banbury mixer or an extruder. To prepare the composition, the components may be mixed by any known methods. Typically, there are two distinct mixing steps: a premixing step and a melt-mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omittd, and raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device.

In one embodiment of the present invention the composition could be prepared by solution method. The solution method involves dissolving all the ingredients in a common solvent (or) a mixture of solvents and either precipitation in a nori-solvent or evaporating the solvent either at room temperature or a higher temperature of at least about 50° C. to about 80° C. In one embodiment, the reactants can be mixed with a relatively volatile solvent, preferably an organic solvent, which is substantially inert towards the polymer, and will not attack and adversely affect the polymer. Some suitable organic solvents include ethylene glycol diacetate, butoxyethanol, methoxypropanol, the lower alkanols, chloroform, acetone, methylene chloride, carbon tetrachloride, tetrahydrofuran, and the like. In one embodiment of the present invention the non-solvent is at least one selected from the group consisting of mono alcohols such as ethanol, methanol, isopropanol, butanols and lower alcohols with C1 to about C12 carbon atoms. In one embodiment the solvent is chloroform.

In one embodiment, the ingredients are pre-compounded, pelletized, and then molded. Pre-compounding can be carried out in conventional equipment. For example, after pre-drying the polyester composition (e.g., for about four hours at about 120° C.), a single screw extruder may be fed with a dry blend of the ingredients, the screw employed having a long transition section to ensure proper melting. Alternatively, a twin screw extruder with intermeshing co-rotating screws can be fed with resin and additives at the feed port and reinforcing additives (and other additives) may be fed downstream. The pre-compounded composition can be extruded and cut up into molding compounds such as conventional granules, pellets, and the like by standard techniques. The composition can then be molded in any equipment conventionally used for thermoplastic compositions, such as a Newbury type injection molding machine with conventional cylinder temperatures, at about 230° C. to about 280° C., and conventional mold temperatures at about 55° C. to about 95° C.

The molten mixture of the polyester may be obtained in particulate form, example by pelletizing or grinding the composition. The composition of the present invention can be molded into useful articles by a variety of means by many different processes to provide useful molded products such as injection, extrusion, rotation, foam molding calender molding and blow molding and thermoforming, compaction, melt spinning form articles. Non limiting examples of the various articles that could be made from the thermoplastic composition of the present invention include electrical connectors, electrical devices, computers, building and construction, outdoor equipment. The articles made from the composition of the present invention may be used widely in house ware objects such as food containers and bowls, home appliances, as well as films, electrical connectors, electrical devices, computers, building and construction, outdoor equipment, trucks and automobiles. In one embodiment the polyester may be blended with other conventional polymers.

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. While only certain features of the invention have been illustrated and described herein, many modifications and changes will occur to those skilled in the art. Accordingly, these examples are not intended to limit the invention, as defined in the appended claims, in any manner.

TABLE 1

| Abbrerviation | |
|---|---|
| PBT | Polybutyleneterephthalate |
| DMT | Dimethylterephthalate from Garware Chemicals |
| | India Limited |
| BDO | Butanediol from Lancester Research Chemicals |
| ERL | 3,4-epoxycyclohexylmethyl-3,4-epoxycyclohexane |
| | carboxylate (ERL 4221 from Dow Chemicals) |
| DGEBA | Digycidyl ether of bisphenol acetone from CIBA |
| Bisoxazoline | 1,3-Phenylene Bisoxazoline From Takeda Chemicals |
| Bisimidazoline | 1,4-Phenylene Bisimidazoline synthesized inhouse. |
| Zn-Stearate | Zinc Stearate from Sigma Aldrich |
| EI Stage | Ester Interchange stage of polymerization process- A |
| | process of converting reaction mixture into first mixture. |
| TE Stage | Transesterification stage of polymerization process- A |
| | process of converting first mixture into molten mixture. |

The Bisimidazoline compound was synthesized in the laboratory as per the procedure given in journal “Synthesis, Vol 12, Page 963 to 965, 1981” which is included herein as reference.

The residual THF in the resin was estimated by dissolving the resin in Phenol-tetrachloroethane mixture and extracting the THF into solvent. The polymer was separated from the solvent by precipitating the mixture using acetone. The THF in the solvent was later estimated by Gas Chromatography. The intrinsic viscosity of the polymer was measured using a Ubhellode Viscometer with Phenol Tetrachloroethane mixture of 60:40 ration by weight and the measurements were carried out at 25° C. The acid number was measured using a FRIR. The sample was pressed into a thin and transparent film by compression molding at 260° C. and subsequent quenching of the film in acetone solvent to make the film transparent. The transparent films were used to record the IR spectrum and the carboxylic value was determined using the spectrum. The melting point and the crystallization temperature were measured using differential scanning calorimetry with a heating and cooling rate of 20° C./min for two cycles. The second cycle data were recorded.

Comparative Example C.Ex.1: In process for making polyester, the monomers-dimethylterephthalate (1 mole supplied by Garware Chemicals Limited, India of 99.5% pure) and butanediol (1.6 moles supplied by Lancester Research Chemicals of 99% pure) were charged into a reactor. The mixture was heated until the monomers were melted.

When the melt reached 150° C., 100 ppm of titanium catalyst was added and the reaction was continued. The overhead products like methanol and tetrahydrofuran (THF) byproducts were removed continuously and collected in a receiver as a function of time. Simultaneously the temperature was also raised to 230° C. over a period of 1 hour to ensure the completion of ester interchange of the polymerization process (EI stage). Vacuum was then applied in steps from a pressure of 900 mbar to 0.5 mbar over a period of 30 minutes. The excess butanediol and THF were also recovered as overhead products. The mixture was maintained under this vacuum and the temperature was raised simultaneously to 255° C. over the next 30 min. The melt was maintained at this condition for another 50 minutes of transesterification step of the polymerization process (TE stage). The resulting polymer was then drained and drawn as strand and pelletized to give a neat resin. The total THF generated as overhead product is analyzed. The polymer was analyzed for intrinsic viscosity, carboxylic acid number and molecular weight.

Examples 1 to Example 12: In a batch process for making PBT, the monomers-DMT and BDO were charged into the reactor. Along with these monomers, 1000 ppm of ERL 4221, 25 ppm of zinc stearate was charged. The mixture was heated and the monomers were melted. When the melt reached a temperature of about 150° C., 100 ppm of titanium catalyst was added and the reaction was continued. The overhead products like methanol and THF byproduct was removed continuously and collected in a receiver with respect to time. Simultaneously the temperature was also raised to about 230° C. for over a period of 1 hour. To this mixture another 1000 ppm of epoxy (ERL 4221) was added. Then the system was subjected to vacuum in steps from a pressure of about 900 mbar to about 0.1 mbar over a period of 30 minutes. The excess BDO and THF were recovered as an overhead product with respect to time. The mixture was maintained under vacuum and the temperature was raised simultaneously to about 255° C. over a period of about 30 min. The melt was maintained at this condition for another 50 minutes. The mixture was drained and drawn as strand and pelletized to give the polyester. The total THF generated as overhead product was analyzed using gas chromatography. The various examples of organic compound employed in the process and the various stages of additions are shown in Table 2.

TABLE 2

| | | | | THF | | | Melting | |
|---|---|---|---|---|---|---|---|---|
| | | | Intrinsic | (overhead) | THF | Acid | Point | Crystallization |
| | | | Viscosity | g/350 g | (residual) | Number | (Tm) | temperature |
| | Additive | Addition Stage | (dl/g) | of PBT (g) | (ppm) | (meq/Kg) | (° C.) | (Tc) (° C.) |
| C. Ex. 1 | PBT | — | 0.99 | 8.5 | 554 | 65 | 225.1 | 185 |
| Ex. 1 | PBT + ERL + Zn | 1000 ppm ERL and 25 ppm Zn | 1.01 | 3.3 | 512 | 26 | 225.2 | 184.3 |
| | Stearate with ERL in | Stearate in EI stage + 1000 ppm ERL | | | | | | |
| | split addition | in TE stage | | | | | | |
| Ex. 2 | PBT + ERL | 2000 ppm ERL in EI | 1.00 | 4.0 | 547 | 30 | 224.8 | 185.1 |
| Ex. 3 | PBT + DGEBA in split | 1000 ppm DGEBA in EI stage and | 1.01 | 4.9 | 502 | 34 | 224.9 | 187 |
| | addition | 1000 ppm DGEBA in TE stage | | | | | | |
| Ex. 4 | PBT + Bisoxazoline + | 500 ppm bisoxazoline in EI stage and | 1.01 | 5.1 | 443 | 27 | 225.3 | 183 |
| | DGEBA | 500 ppm bisoxazoline + 1000 ppm | | | | | | |
| | | DGEBA in TE stage | | | | | | |
| Ex. 5 | PBT + Bisoxazoline + | 750 ppm bisoxazoline in EI stage and | 0.98 | 6.3 | 252 | 15 | 224.5 | 184.8 |
| | DGEBA | 750 ppm bisoxazoline + 500 ppm | | | | | | |
| | | DGEBA in TE | | | | | | |
| Ex. 6 | PBT + Bisoxazoline + | 750 ppm bisoxazoline in EI stage and | 0.99 | 6.2 | 307 | 18 | 224.6 | 183.9 |
| | DGEBA | 750 ppm bisoxazoline + 1000 ppm | | | | | | |
| | | DGEBA in TE | | | | | | |
| Ex. 7 | PBT + Bisimidazoline | 200 ppm Bisimidazoline in EI stage | 0.96 | 7.5 | 286 | 27 | 224.6 | 187.1 |
| Ex. 8 | PBT + Bisimidazoline | 1000 ppm Bisimidazoline in EI stage | 0.98 | 8.5 | 259 | 10 | 225.2 | 185.1 |
| Ex. 9 | PBT + Bisoxazoline | 1000 ppm Bisoxazoline in EI stage | 0.99 | 6.3 | 235 | 33 | 224.3 | 184.7 |
| Ex. 10 | PBT + Bisoxazoline | 2000 ppm Bisoxazoline in EI stage | 0.92 | 7.2 | 590 | 28 | 225.1 | 186.1 |
| Ex. 11 | PBT + Bisoxazoline | 500 ppm bisoxazoline in EI stage + | 0.95 | 8.4 | 526 | 32 | 224.6 | 185.4 |
| | | 500 ppm bisoxazoline in TE + 500 | | | | | | |
| | | ppm bisoxazoline to the molten | | | | | | |
| | | mixture | | | | | | |
| Ex. 12 | PBT ++ DGEBA | 1000 ppm DGEBA to the molten | 0.94 | 8.5 | 441 | 22 | 224.9 | 183.9 |
| | | mixture. | | | | | | |

The Table 2 indicates a reduction in THF generated in the overhead stream and also in the residual content. It also indicates that there was a reduction of acid number by addition of reactive organic compounds such as epoxies or bisimidazoline or bisoxazoline or combination of these. In presence of a mixture of catalysts the effect of epoxy on reduction in THF generation was maximum in the overhead and upto 61% reduction was observed in THF generation. When the epoxy was added in a split manner the reduction in THF was improved. The addition of epoxy to the molten mixture at the end of the reaction before draining resulted in lowering of acid number while there was not much reduction in the overhead THF. Table 2 indicates a significant reduction in acid number with addition of epoxies.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A process to make a polyester, wherein said polyester comprises
a) substituted or unsubstituted diacid or diester;
b) substituted or unsubstituted diol; wherein said diol comprises at least about 0.5 mole percent of butanediol;
c) 0.01 weight percent to about 15 weight percent based on the total weight of the composition a reactive organic compound wherein said organic compound comprises of at least one functional group;
and wherein said process comprises:
heating said diacid, diol and said reactive organic compound at a temperature in the range of between about 125° C. to about 250° C. in presence of an effective amount of catalyst to form a reaction mixture;
removing from said reaction mixture by products to form a first mixture;
heating said first mixture at a temperature in the range of between about 180° C. to 320° C.;
draining said molten mixture to form the polyester.

2. The process of claim 1, wherein said diol is at least one selected from the group consisting of straight chain, branched, or cycloaliphatic alkane diols containing about 2 to 20 carbon atoms.

3. The process of claim 1, wherein said diol is at least one selected from the group consisting of ethylene glycol; propylene glycol, butanediol, pentane diol; dipropylene glycol; 2-methyl-1,5-pentane diol; 1,6-hexane diol; decalin dimethanol, bicyclo octane dimethanol; 1,4-cyclohexane dimethanol and particularly its cis- and trans-isomers; triethylene glycol; 1,10-decane diol; tricyclodecane dimethanol; hydrogenated bisphenol-A, tetramethyl cyclobutane diol, para xylene glycol, meta xylene glycol and otho xylene glycol.

4. The process of claim 1, wherein said diacid is at least one selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid and succinic acid or their chemical equivalents.

5. The process of claim 1, wherein the polyester is at least one selected from the group consisting from polybutyleneterephthalate, polybutylene naphthalate, and polybutylene succinate.

6. The process of claim 1, wherein said polyester comprises from about 0.5 to about 100 mole percent of butanediol.

7. The process of claim 1, wherein said reactive organic compound comprising at least one functional group is at least one selected from the group consisting of epoxy, carbodiimide, orthoesters, anhydrides, oxazoline, and imidazolines.

8. The process of claim 1, wherein said reactive organic compound comprising at least one functional group is at least one selected from the group consisting of epoxy, oxazoline, and imidazolines.

9. The process of claim 1, wherein said reactive organic compound comprising at least one functional group is present in an amount between about 0.01 weight percent and 15 weight percent based on the amount of the polyester.

10. The process of claim 1, wherein said heating of the first mixtures is carried out under pressure of about 300 kPa to about 0.01 kPa.

11. The process of claim 1 wherein said catalyst is at least one selected from the group consisting of metal salts of transition metals, tetramethyl, tetraethyl, tetra(n-propyl), tetraisopropyl and tetrabutyl titanates; dialkyl tin compounds, di-(n-butyl) tin dilaurate, di-(n-butyl) tin oxide, di-(n-butyl) tin diacetate; magnesium oxides, magnesium acetate, magnesium sulfate, calcium oxides, calcium acetate, calcium sulfate, germanium oxides, germanium acetate, germanium sulfate, zinc oxides, zinc acetate, zinc sulfate, dibutyl tinoxide, antimony trioxide, sodium polystyrenesulfonate, titanium isopropoxide and tetraammoniumhydrogensulfate and mixtures thereof.

12. The process of claim 1 wherein said catalyst is present in an amount in the range of between about 5 ppm to 2000 ppm.

13. The process of claim 1, wherein said by products are removed by disltillation.

14. The process of claim 1, wherein said by products comprise tetrahydrofuran.

15. The process of claim 1, wherein said reactive organic compound is added to the reaction mixture.

16. The process of claim 1, wherein said reactive organic compound is added to the first mixture.

17. The process of claim 1, wherein said reactive organic compound is added to the molten mixture.

18. The process of claim 1, wherein said reactive organic compound is added stepwise.

19. The process of claim 1 wherein said molten mixture may further be heated to remove said by products.

20. The process of claim 1 wherein said heating to form the reaction mixture is optionally carried out in presence of an inert atmosphere.

21. The process of claim 20 wherein said inert atmosphere is nitrogen atmosphere.

22. The process of claim 20 wherein said inert atmosphere is carbon dioxide atmosphere.

23. The process of claim 20 wherein said inert atmosphere is argon atmosphere.

24. The process of claim 1 wherein said method is a batch polymerization.

25. The process of claim 1 wherein said method is a semi continuous polymerization.

26. The process of claim 1 wherein said method is a continuous polymerization with atleast two reactors in series or parallel.

27. The process of claim 1 wherein the byproduct comprises butanediol.

28. The process of claim 1 wherein the byproduct is recycled to the reaction mixture.

29. The process of claim 1, wherein said molten mixture may optionally be extruded.

30. The process of claim 1, wherein said polyester may further comprise a filler, said filler is at least one selected from the group selected consisting of calcium carbonate, mica, kaolin, talc, wollastonite, glass fibers, carbon fibers, carbon nanotubes, magnesium carbonate, sulfates of barium, calcium sulfate, titanium, nano clay, carbon black, silica, hydroxides of aluminum or ammonium or magnesium, zirconia, nanoscale titania, or a combination comprising at least one of the foregoing fillers.

31. The process of claim 30, wherein said filler is present in an amount between about 0.1 weight percent and 60 weight percent based on the amount of the polyester.

32. The process of claim 1 wherein said polyester may further comprise the addition of an additive.

33. The process of claim 32, wherein said additive is selected from the group consisting of flame retardants, anti-oxidants, reinforcing materials, colorants, mold release agents, nucleating agents, UV light stabilizers, heat stabilizers, lubricants, antioxidants, pigments or combinations thereof.

34. The process of claim 32, wherein said additive is present in an amount between about 0.1 and about 30 weight percent based on the amount of the polyester.

35. A process to make a polyester, wherein said polyester comprises structural units derived from
a) substituted or unsubstituted diacid or diester;
b) substituted or unsubstituted diol; wherein said diol comprises at least about 0.5 mole percent of butanediol;
c) 0.01 weight percent to about 15 weight percent based on the total weight of the composition a reactive organic compound wherein said organic compound comprises of at least one functional group;
and wherein said process comprises:
heating said diacid, diol and said reactive organic compound at a temperature in the range of between about 125° C. to about 250° C. in presence of an effective amount of at least two catalysts to form a reaction mixture;
removing from said reaction mixture by products to form a first mixture at a pressure in a range of about 300 kPa to about 5 kPa;
heating said first mixture at a temperature in the range of between about 180° C. to about 300° C. to form a molten mixture at a pressure in a range of about 50 kPa to about 0.01 kPa; and
draining said molten mixture to form said polyester.

36. A process to make a polyester, wherein said polyester comprises structural units derived from
a) substituted or unsubstituted diacid or diester;
b) substituted or unsubstituted diol; wherein said diol comprises at least about 1 mole percent of butanediol;
c) 0.01 weight percent to about 2 weight percent based on the total weight of the composition a reactive organic compound wherein said organic compound comprises of at least one functional group;
and wherein said process comprises:
heating said diacid, diol and said reactive organic compound at a temperature in the range of between about 125° C. to about 230° C. in presence of an effective amount of at least two catalysts to form a reaction mixture;
removing from said reaction mixture by products to form a first mixture at a pressure in a range of about 101.3 kPa to about 5 kPa;
adding to said first mixture said reactive organic compound;
heating said first mixture at a temperature in the range of between about 200° C. to about 260° C. to form a molten mixture at a pressure range of about 50 kPa to about 0.01 kPa; and
draining said molten mixture to form said polyester.
